(19) United States
(12) Patent Application Publication
(10) Pub. No.: US 2017/0084203 A1
(43) Pub. Date: Mar. 23, 2017

(54) STEREO 3D HEAD MOUNTED DISPLAY APPLIED AS A LOW VISION AID

(71) Applicant: Jerry G. AGUREN, Tomball, TX (US)

(72) Inventor: Jerry G. AGUREN, Tomball, TX (US)

(73) Assignee: D.R.I. Systems LLC, Houston, TX (US)

(21) Appl. No.: 15/123,989

(22) PCT Filed: Mar. 5, 2015
(86) PCT No.: PCT/US2015/018939

§ 371 Date: Sep. 6, 2016

Related U.S. Application Data
(60) Provisional application No. 61/949,355, filed on Mar. 7, 2014.

(51) Int. Cl. G09B 21/00; G06F 3/16; H04N 5/232; A61H 5/00

(52) U.S. Cl. CPC G09B 21/008; A61H 5/00; G06F 3/167; H04N 5/23258; H04N 5/23267; A61H 2201/165; A61H 2201/1604

(57) ABSTRACT

Embodiments of this invention generally relate to three dimensional head mounted displays (HMD) with stereo cameras that could be used as a vision platform for applications that modify the camera images to benefit people who suffer from eye diseases, brain trauma, and brain diseases. Embodiments take images from stereo cameras that are integrated into a head mounted display. Images generated by the stereo cameras are routed through an external image processing system that is worn by the goggle wearer before they are sent back to the goggle's three dimensional stereo displays. The image processor also uses voice commands that reconfigure the goggle vision system to process images based on a predefined organization for a specific activity.

### FIELD OF INVENTION

Embodiments disclosed herein relate to the field of 3D stereo goggles or Head Mounted Displays (HMD), that are used as low vision aids for medical conditions that involve the lens, retina, optic nerve, or brain.

### DESCRIPTION OF RELATED ART

Retinal diseases currently affects millions of people in the US. In the US alone there are 10 million people suffering from Age-related Macular Degeneration (AMD), that is 1 in 30 people suffer from some form of AMD. In addition, AMD is growing by 200,000 new cases each year. Medical solutions are generally limited to slowing the progression of the disease and not curing it. As the disease progresses, the patient slowly loses their sight and eventually goes blind. Low vision aids are limited to simple refractive solutions such as magnifying glasses, and prisms.

In one example, a small video camera and zoom lens is integrated with a small hand held color LCD display and battery. The patient can hold the low vision aid system over a book and the LCD display shows a magnified view of the book page that is in the field of view of the camera. This type of vision aid can be helpful for patients suffering from AMD.

Sometimes vision loss is caused by damage to the optic nerve in the brain. This condition is called hemianopia, where the patient loses half of their visual field in one or both eyes. The loss can be, but not limited to, half of the visual field of view, where the halves are divided superior or inferior, or nasal or temporal. Solutions today traditionally involve placing prisms onto eyeglasses. The prism shifts the half of visual field that has decreased or is totally lost to the other half of the eye that is undamaged and sees normally.

When AMD has progressed to an advanced stage, and the Macular has lost all ability to sense light, a condition called Macular hole may result. The brain sometimes forms a new Macular, called a Preferred Retinal Locus (PRL). The PRL has low density Rods and Cones. This places a limit on how much improvement can be made. There are specialized machines that can determine the location of the PRL. Once the PRL is located, an inter-ocular lens is positioned to assist the eye on focusing on the new PRL as well as provide a fixed 3× magnification.

### BRIEF DESCRIPTION OF FIGURES

FIG. 1 is a block diagram of a vision system.

FIG. 2 is a block diagram of a display controller and goggle.

FIG. 3 is a block diagram of a stereo camera module.

FIG. 4 is a block diagram of a 3D stereo goggle module.

FIG. 5 illustrates different topologies used to implement 3D stereo displays.

FIG. 6 is an exemplary configuration application menu layout.

FIG. 7 is a menu layout of an exemplary system.

FIG. 8 is a block diagram illustrating how the goggle system is configured and how the patient's configuration data is stored in a local database.

FIG. 9 is a block diagram showing how patient data stored in a local database is moved to cloud storage and to DRI Systems' database.

FIG. 10 is a diagram showing how an Activity command is constructed from basic commands.

FIG. 11 is a block diagram illustrating how the trigger word/phrase is used to build one, two, and three word Activity commands.

FIG. 12 is a block diagram showing the main elements required for image stabilization.

FIG. 13 is an image stabilization flow chart.

FIG. 14 illustrates the Pathway between retina and visual cortex in human brain.

FIG. 15 is a projector display with image segmentation.

### SUMMARY OF INVENTION

Embodiments of the invention include a new application for Head Mounted Displays (HMD) that is applied as a low vision aid for people suffering from eye diseases, brain trauma, and brain diseases that cause loss if sight. Features may include a wide horizontal field-of-view and a wide vertical field-of-view, a binocular overlap between the left and right eye, and high visual acuity. In addition, the HMD may be voice activated and reconfigurable by the wearer stating a specific activity.

### DETAILED DESCRIPTION

The embodiment of this invention presented in this section consists of three components; a three dimensional stereo goggle based display with sensors, an external electronic image processing package, and a battery pack. The invention described herein is applied as a low vision aid for people suffering from, but not limited to, diseases like age-related macular degeneration, retinitis pigmentosa, and hemianopia, among others.

Embodiments apply methods from multiple engineering disciplines, such as, system design, electrical engineering, mechanical engineering, optical engineering, control theory, and software design; with the primary features of wide field-of-view (FOV), head tracking, image processing, and three dimensional FOV.

One embodiment of this invention is similar in size and form to ski goggles. In this design the ski goggle front glass is replaced by a LCD array 502. The LCD is comprised of an array of electrically controlled elements that are called pixels. The horizontal axis of the LCD array is divided into two parts, left 505, and right 508. The image generated by the LCD array 403 and 502 is captured and focused into each eye by lens element 404. The eyepiece formed by lens element 404 can be implemented with one or multiple elements. The eyepiece can also be designed to move the lens elements such that the wearer's spherical and cylindrical (astigmatism) prescription can be set uniquely for both the left and right eyes.

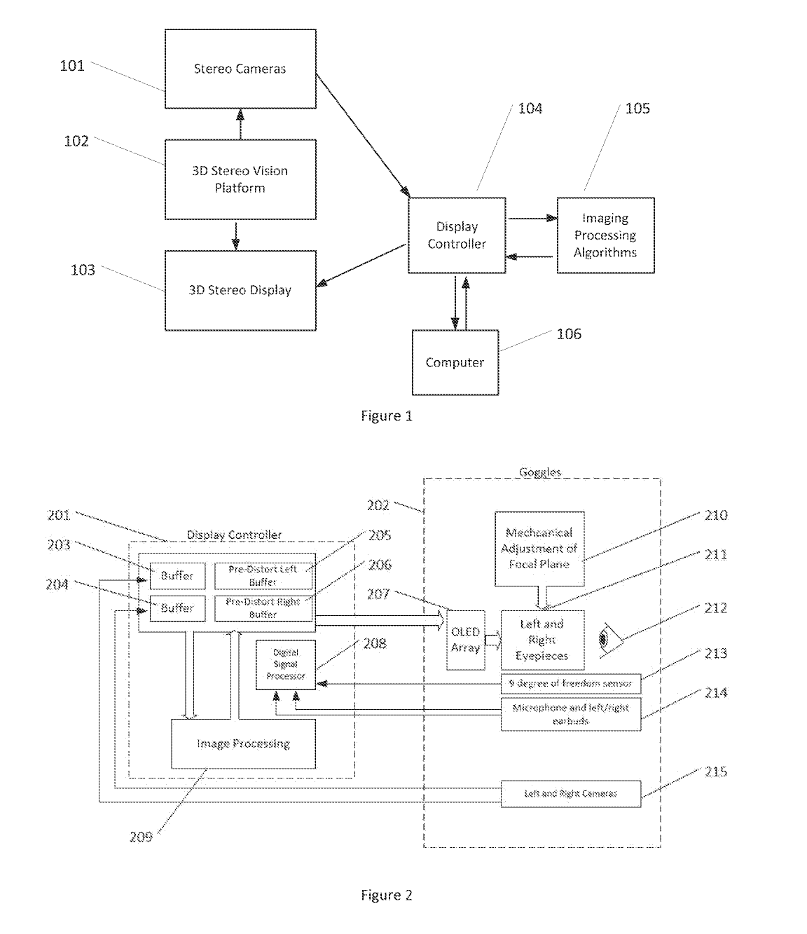

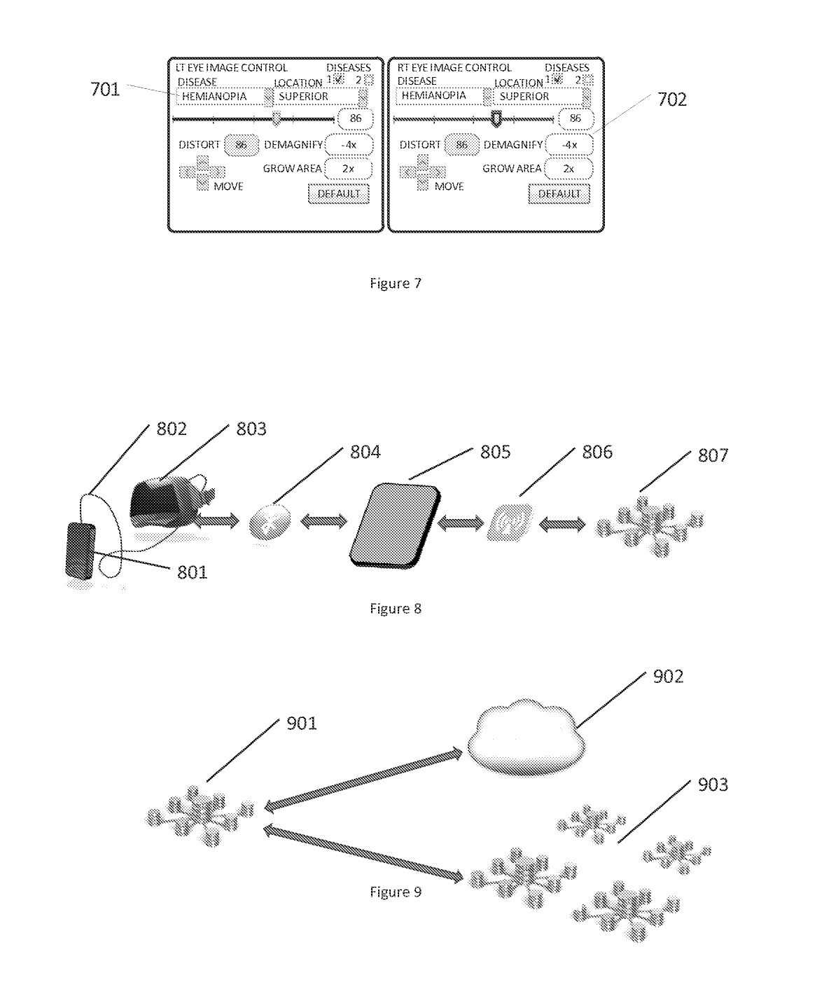

A block diagram shown in FIG. 1 identifies the main components of one embodiment disclosed herein. The stereo camera module 101 attaches to the front of the goggle assembly 102, 203. A display controller 104 separate from the 3D stereo display processes the camera inputs 101 and the sensor inputs 102. The inputs are used by a combination of software algorithms 105 and Application Specific Integrated Circuits (ASIC)s to calculate the outputs that are driven electrically to the 3D Stereo display 103. A battery module 106 attaches to the display controller. Power from the battery is used to supply power to all systems that comprise the vision platform. Healthcare professionals may use a computer with custom application (see FIG. 7) to configure the goggles specifically for each patient 106. Once the configuration is complete, the computer 106, 805 is disconnected from display controller 104, 801.

Image data coming from the stereo camera module 215 feeds into the display controller 201 shown in FIG. 2. The primary function of the display controller is to receive the stereo camera data from the camera modules, receive sensor data coming from the goggles 213, and process the electronic stream of data coming from the voice recognition microphone 214. The video streams are initiated based on the commands stored for different activities which then triggers a configuration that modifies the video stream specifically for that activity.

The display controller initially receives camera data frames in digital video buffers 203, 204. From the video buffers, the frame data is moved to the pre-distort buffers 205, 206. During the transfer between the video buffer and the pre-distort buffer, the frame is modified by either an ASIC chip 209 or the Digital Signal Processor 208. The image is modified based on the wearer's low vision aid requirements and is pre-distorted in order to compensate for the distortions caused by the goggle's optics. Image frames are transferred from the pre-distort buffers to the LCD array (or LED, or any similar technology) in the goggle's display 207.

In addition to the camera inputs, the display controller also processes digital or analog microphone data and raw sensor information. One embodiment of this invention integrates a microphone into the goggles 214 for the purpose of monitoring speech of the wearer. A digital signal processor 208 executes software that converts the speech into verbal commands. The commands are then used to perform different tasks, such as, configuring the camera frame image processing in a way that allows the wearer to read, watch television, or to take a walk.

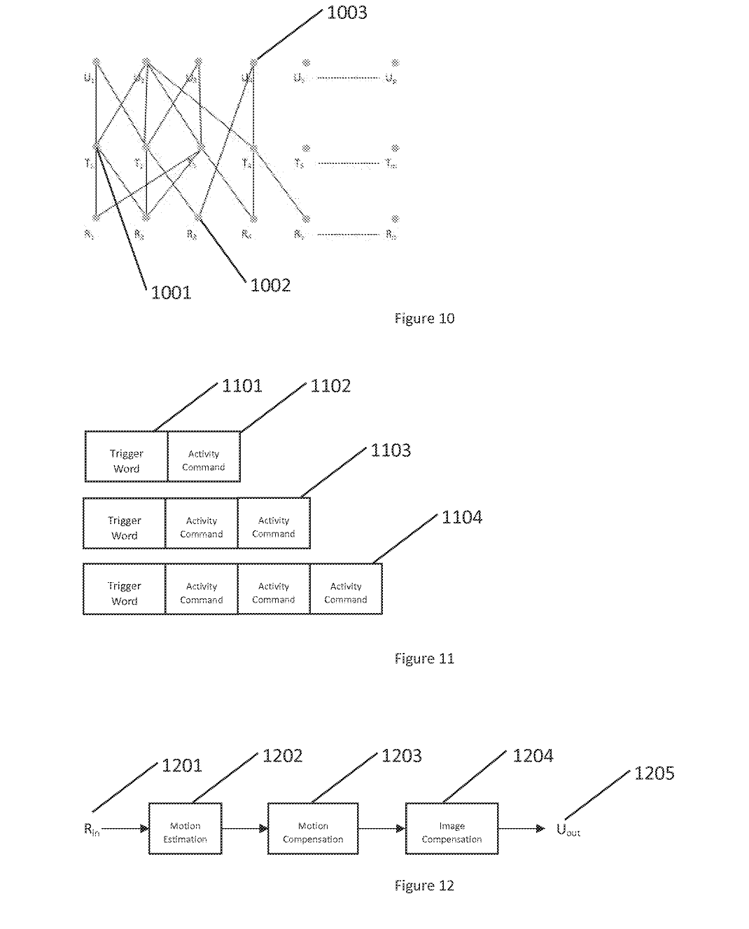

An activity command is a voice initiated command that has a hierarchical structure as shown in FIG. 10. At the lowest level are the basic commands, for example, magnification, brightness, color inversion, image stabilization, and edge detection. This level of command is depicted in FIG. 10 with the variable R. Let set S₁ represent these low level commands as given in equation 1 below.

S₁={R₁,R₂,R₃,R₄,R₅, . . . Rₙ} eq. 1

The next two levels are activity commands represented by the variables T and U. Let sets S₂ and S₃ represent activity commands as shown in equations 2, 3.

S₂={T₁,T₂,T₃,T₄,T₅, . . . Tₘ},T₅=NULL eq. 2

S₃={U₁,U₂,U₃,U₄,U₅, . . . Uₚ},U₅=NULL eq. 3

Activity commands are built on commands from lower levels. Activity commands in set S₂ are built using the basic commands R₁-Rₘ. For example, the first activity command T₁ is shown in equation 4 constructed from basic commands R₁ and R₂. Let R₁ equal magnification and R₂ equal image stabilization, then activity command T₁ is R₁ and R₂ for the activity command Read. The next level set S₃ illustrates how multi-level commands can be formed. Equation 5, element U₄ is built using two commands R₃ and T₄. This is an activity command combined with a basic command. An example of this is watching television in low light. The act of watching television is an activity command defaulted in ambient light. When the lights are out, the goggles must change the light metering to center of frame only which is a low level command.

T₁₋₄=[{R₁,R₂},{R₂,R₃},{R₁,R₂},{R₄,R₅}] eq. 4

U₁₋₄=[{T₁,T₂},{T₁,T₂,T₃,T₄},{T₂,T₃},{R₃,T₄}] eq. 5

Activity commands are assigned words that are common in daily life, such as read, walk, watch television, or read medicine bottle. In order for the voice recognition not to execute during normal conversation, a trigger word is used. The trigger word can be defined by the user as any word, for example VUE is assigned as the default trigger word. FIG. 11 shows three block diagrams for one, two, and three activity command sequences. All three command sequences start with the trigger word VUE 1101. An example of a single activity command sequence is “VUE Read” 1102. A two activity command sequence 1103 example is “VUE watch TV living room”. Here watch is not used, but TV and a hyphenated living-room are used as a two word command. The patient may have different televisions in different rooms, with different screen sizes, and at different distances. An example of a three word command is “VUE watch TV in low light” 1104. The trigger word “VUE” starts the sequence, “TV” is the first activity command, “low” is the second activity command, and “light” is the third activity command.

The VUE is a vision system where the goggle 803, display controller 801 and cable 802 connecting them are important components of a larger architecture as shown in FIG. 8. Configuration of the goggle system is done by health professionals. Typically this will be Optometrists, Ophthalmologists, and Retinal Specialists. A health professional may have one computer or multiple computers to configure the goggle system. FIG. 8 shows a tablet computer 805 connected to a goggle over Bluetooth 804 for the configuration. As time progresses, the configurations of many patients will be stored on a tablet computer. A Wi-Fi interface 806 is used to store the patient's configurations in a local database 807. Storing patient configurations not only protects the data from computer failure, but also provides a method for the health professional to monitor and analyze the patient's vision over time.

In addition to moving the patient's configuration data to a local database, another layer of data protection and data analysis is shown in FIG. 9. The data stored in the local database 807, 901 is periodically copied to cloud storage 902. Data stored in the local database and cloud storage follow Electronic Medical Records (EMR) standards.

Data is also moved from the local database to a company database 903 for long term analysis. Before the data is copied to the company database, all patient's private information is removed. Only the sex, age, and baseline medical state along with the configuration data are moved to the company database.

One embodiment of this invention uses sensors in the goggles 213 to enhance the quality of the camera frame images that are displayed to the goggle wearer. One example, is a sensor that monitors the acceleration of the goggle wearer's head in three orthogonal axes. With the addition of a vertical reference sensor in combination with the accelerometer sensor this data is sufficient to provide image stabilization for the goggle wearer. The digital signal processor 208 would use the sensor data to determine the position of the wearer's head by inertial reference. Image stabilization is necessary when the wearer is viewing a magnified display.

One implementation of image stabilization uses physical data about the goggle instead of analyzing the video frames. An accelerometer and vertical reference sensors are mounted in the goggle. The acceleration of the camera and goggles are the same since the cameras are rigidly attached to the goggles. FIG. 11 shows that image stabilization consists of a three step process. Initially, an estimation of motion 1202 is made for the video frame input Rᵢₙ 1202 and 1201. The motion estimate comes from calculating the velocity and position of the goggle. Velocity is determined by integrating the acceleration and position is found by integrating velocity. For each integration, there is a constant and this constant that causes drift in the actual velocity and position. The vertical reference is used to cancel the majority of the velocity error and position error caused by the constants. The accelerometer sensor should be a three axes sensor. The single velocity vector and single position vector are calculated from the three axes acceleration sensor.

The next step in image stabilization is motion compensation 1203. The current velocity and position are compared to the previous velocity and position frames. The difference between the last frame and the current frame determine the behavior of the image stabilization process.

The last stage in image stabilization is to compensate for motion if the motion is within a band of velocities and relative positions 1204. If the velocity and position are outside of the band, then there is no image compensation. The output Uₒᵤₜ 1205 consists of a motion compensated image if velocity and position are within established velocity and position bands. If either velocity or position are outside their respective bands, then the image is not modified.

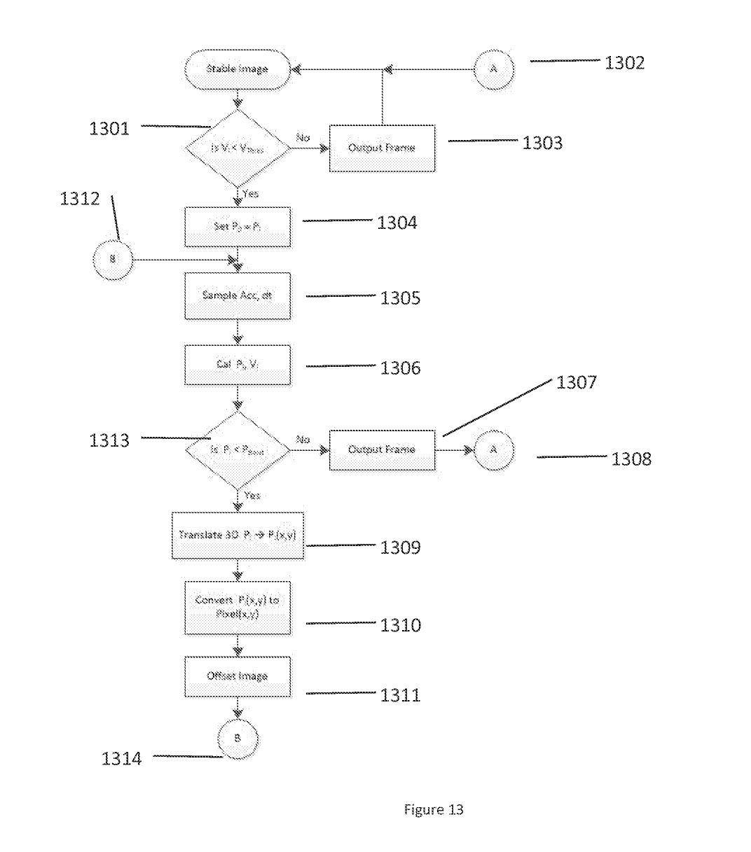

The image stabilization process is outlined by the flow chart shown in FIG. 13. Initially, the process begins by starting at input B 1312. The accelerometer and vertical reference values are read by the display controller from the sensors mounted in the goggle 1305. Both the accelerometer and vertical reference values are three dimensional vectors. The velocity vector and position vector are calculated from the acceleration by taking the first and second integration for velocity and position, respectfully 1306. The first time through Pi=P0 so the decision block 1313 will be no, so the frame will be sent to the goggles unmodified 1307. After the frame is sent to the goggle display, the next flow chart state is at A 1308, 1302.

After the initial pass through the flow chart, there exists a current state, denoted with (i), such that there is a position vector (pi) and a velocity vector (vi). The first decision is to check if the goggle wearer is moving his head faster than the image stabilization can compensate 1301. If the velocity is at about the threshold, then the image is sent out to the goggle's display unmodified 1303. The last state position vector (p0) is set equal to the current state position vector (pi) 1304. A new set of current velocity vector and position vector are calculated 1306 by reading the accelerometer in the goggles 1305. The current position Pi is compared to a maximum limit (Pband) 1313. If the current position is greater than the maximum position vector, then the frame is not modified and is sent to the goggle's display 1307. The next state of the flow chart is to return to the top 1308.

If the current position vector is less than the maximum position vector, the image will go through the image stabilization process. The process starts by translating the current position vector (pi) to two dimensions because each display is two dimensional 1309. Then, depending on the camera magnification and camera vergence, the two dimensional current position is converted to a new two dimensional point (x, y) 1310. This new converted (x, y) point becomes the pixel offset used on the image frame 1311. The next state of the flow chart 1314 is to re-enter the flow chart at point B 1312. The process described is for only one camera. Both the right eye camera frames and left eye camera frames go through the same flow chart.

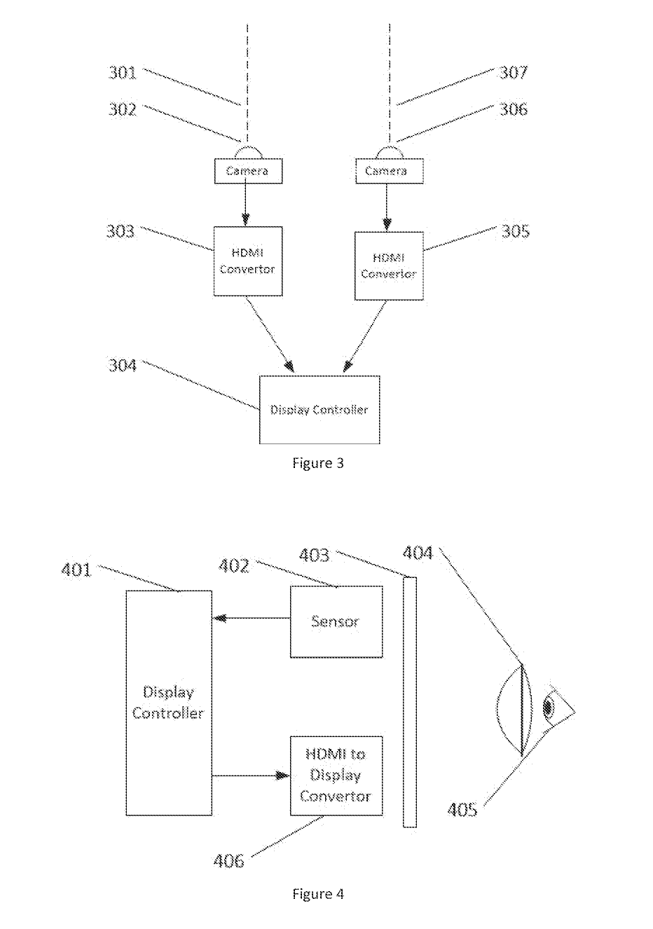

The stereo camera module 101 provides two images that are separated horizontally by 64 mm and with the optical axes of each camera aligned in parallel, FIGS. 3, 301 and 307. One implementation of the invention uses small low cost cameras 302 and 306 that are traditionally used in mobile phones. The cameras can provide an analog (A) output or a digital output (D). Before the camera data is transmitted to the display controller 304, the camera's output must be converted to a protocol that can be sent serially over a cable between the goggle and display controller. Both camera outputs are converted to High-Definition Multimedia Interface (HDMI) 303 and 305.

One embodiment of the goggles 103 is shown in the block diagram FIG. 4. The main elements are a display 403, an optical system or eyepiece 404, facilities for sensors 402, and electronics to receive a High Definition Multimedia Interface (HDMI) signal 406 for both cameras from the display controller 401. The two images supplied by the stereo cameras described in [20] are modified by the display controller then presented to the wearer's eyes 405 through the display 403. The two stereo images while separated in space have 100% overlap in respective field of views.

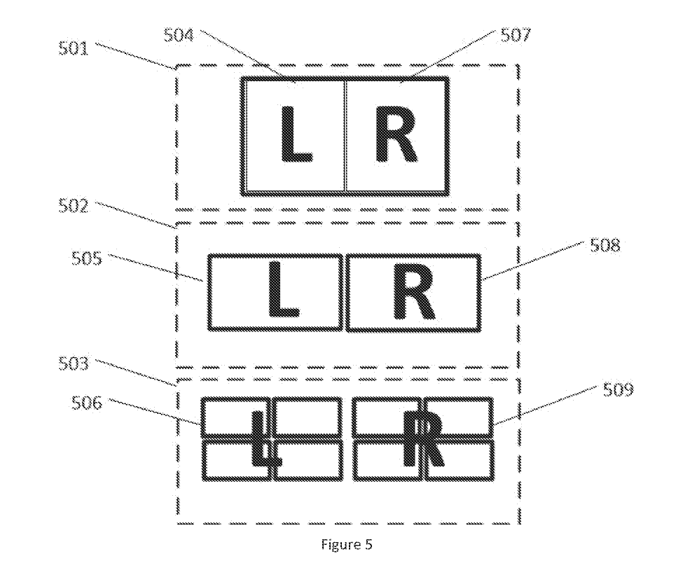

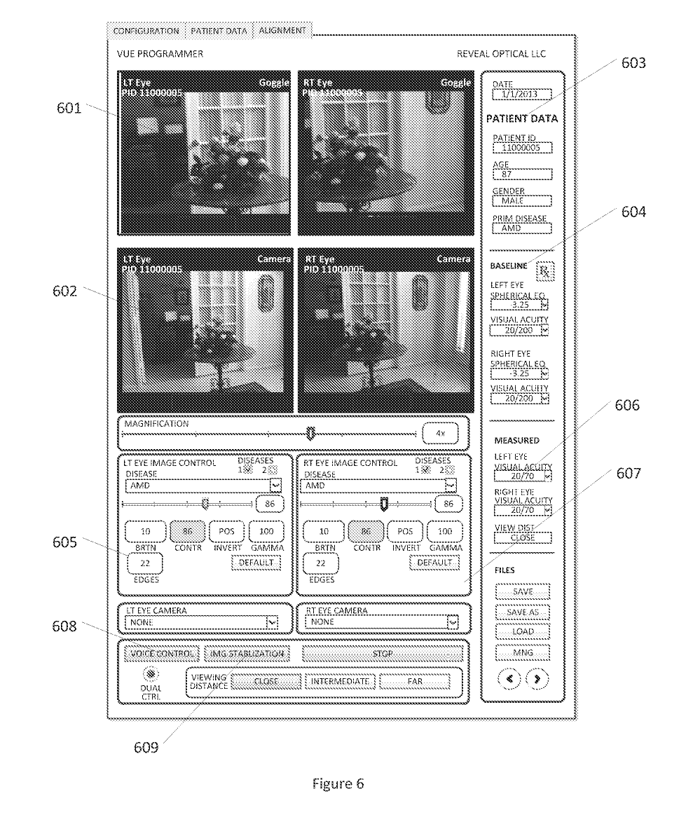

Embodiments herein implement one of several methods to display a stereo three dimensional image to the goggle wearer. Examples of the different configurations are shown in FIGS. 5 and 15. One embodiment uses a singular display 501 then divides the display electronically into two parts, with one half for the left eye 504 and the other half for the right eye 507. An alternative method is to dedicate a display to each eye as shown in 502. One display is assigned to each eye, 505 for the left and 508 for the right. Another method uses multiple displays for each eye as shown in FIG. 5. In this embodiment, four displays are arranged side by side. The image for each eye is then divided electronically in a way that represents the arranged geometry of the displays for left and right eyes by 506 and 509, respectively. The final method is shown in FIG. 15. The goggle 1504 uses a micro projector, one for each eye 1501, 1502, to project an image onto a flat surface 1503. Since the projectors when used in a HMD application would need to be mounted above the wear's head and pointed down at an angle, the display surface is required to have a Lambertian reflection in order for the image to be seen by the goggle wearer. The image displayed is seen by the wearer the same way as the LCD system is focused on the retina by a wide angle eyepiece 403, 404, 405. Another embodiment of the projector design is based on the concept of segmenting the image displayed. In this implementation, each image for each eye is divided into six segments. The physical placement of the six segments are two rows and three columns as shown in 1505, 1506, 1507, 1508, 1509, and 1510. The projector receives each of the six segments from the display controller and flashes the segmented image onto the display. The length of the flash is determined by the scanning mechanism. The maximum flash length cannot be more than the time it takes to travel half of the distance between two pixels. If the flash is longer than half the pixel distance, the image will “smear” resulting in a loss of resolution. It is assumed that the time to update all six segments is less than 33 milliseconds (30 Hertz) so flicker is not perceived by the wearer.

The implementation of embodiments described in the previous sections focuses on providing a patient a means to optimize their existing vision. An additional function described henceforth will, for some eye diseases and/or brain injuries, improve the patient's vision. The primary mechanism to improve vision takes advantage of the ability for some portions of the brain and retina to remap dendrite/synaptic connections, a process called neuroplasticity.

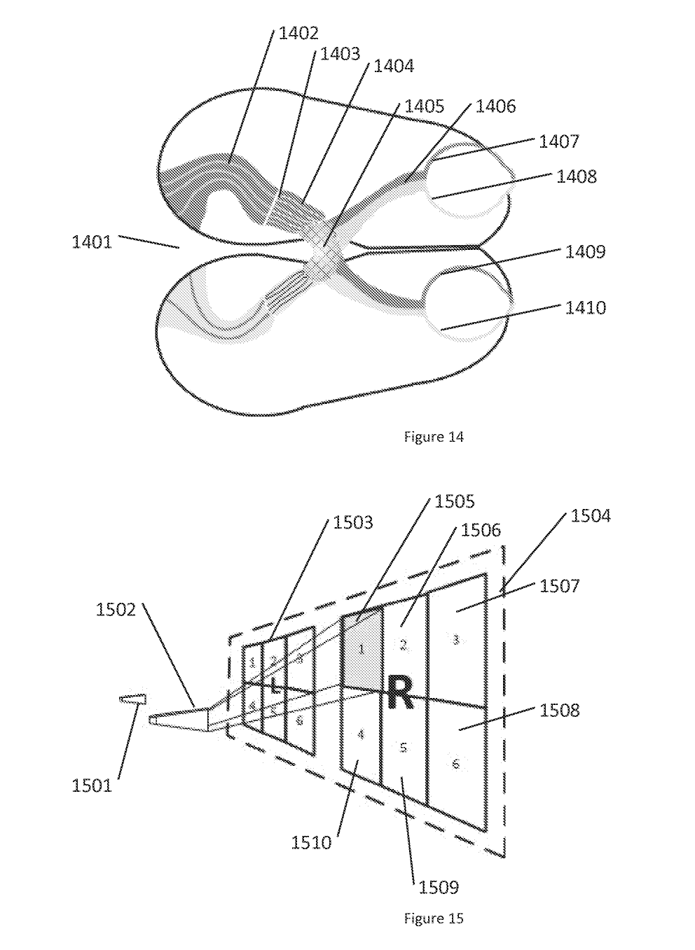

FIG. 14 illustrates the primary pathway between the retina and visual cortex 1401. The retina for each eye is divided into halves as shown by 1407, 1408 and 1409, 1410. Both retinal halves for each eye combine to form the optic nerve. The optic nerve for the left eye is shown by 1406. The optic nerve connects to the optic chiasm 1405 where the retinal halves cross over from each eye. The nasal halves of the retina 1408 and 1409 swap hemispheres where the left half goes to the right half and the right half goes to the left half. This results in retinal halves 1408 and 1409 combining in the optic chiasm and continuing through to the optic tract on the right hemisphere of the brain. To complete, the neurological optic fiber path 1407 and 1409 combine in the optic chiasm to continue onto the left optical tract 1404. The fibers of the optic tract continue until they terminate synaptically at the dorsal lateral geniculate body 1403. Visual information is relayed from the geniculate body to the visual cortex 1401 by the optic radiation or geniculocalcarine 1402.

Depending on the eye disease or vision loss due to some brain impairments, the goggle system can use habitual optical pattern presentations to cause some neurological remapping to occur at the retinal level 1407, 1408, and 1409, 1410 or other parts in the optical pathway from the retina 1407, 1408 to the visual cortex 1401.

Another embodiment of this invention uses a combination of drugs and habitual light training to case synaptic remapping at anywhere from the retina to the visual cortex 1401.

1. An imaging device, comprising:
goggles having a first display system and a second display system, the first display system configured to provide information to a left eye and the second display system configured to provide information to a right eye of the user;
one or more image generating devices, the image generating devices receiving image data;
one or more sensors, the sensors configured to collect data regarding acceleration, gravity field direction and magnetic direction as related to the goggles;
a microphone affixed to the goggles, the microphone configured to receive input from the user; and
a display controller configured to:
to receive the image data from the image generating devices;
receive data from the one or more sensors;
process user input as received by the microphone; and
produce an adjusted image, the adjusted image compensating for a retinal disease of the user, the first display system and the second display system receiving the adjusted image.

2. The imaging device of claim 1, wherein the first display system and the second display system use a singular display which is divided into two parts.

3. The imaging device of claim 1, wherein the first display system and the second display system each comprise one or more displays.

4. The imaging device of claim 1, further comprising an application to configure the display controller with patient specific configuration data.

5. The imaging device of claim 1, wherein the retinal disease compensated for is selected from the group consisting of Age-Related Macular Degeneration, Retinitis Pigmentosa, Diabetic Retinopathy, Glaucoma, Epiretinal Membrane or combinations thereof.

6. The imaging device of claim 1, wherein the input from the user comprises one or more activity commands.

7. The imaging device of claim 1, wherein the display controller is connected with a computer, the display controller providing information about changes in the retinal disease of the user.

8. A method of adjusting an image, comprising:
capturing a left image using a left image generating device and a right image using a right image generating device;
capturing positioning data including acceleration, gravity field direction and magnetic direction data with relation to the left image and the right image;
delivering the left image, the right image and the positioning data to a display controller, the display controller adjusting the left image and the right image to compensate for a retinal disease and creating an adjusted left image and an adjusted right image; and
delivering the adjusted left image to a left display system and the adjusted right image to a right display system.

9. The method of claim 8, further comprising the display controller receiving one or more activity commands.

10. The method of claim 9, wherein the activity commands include verbal commands for magnification, brightness, color inversion, image stabilization, edge detection or combinations thereof.

11. The method of claim 8, wherein the positioning data includes nine degrees of freedom.

12. The method of claim 8, wherein the retinal disease compensated for is selected from the group consisting of Age-Related Macular Degeneration, Retinitis Pigmentosa, Diabetic Retinopathy, Glaucoma, Epiretinal Membrane or combinations thereof.

13. The method of claim 8, wherein adjusting the left image and the right image comprises real time image stabilization.

14. The method of claim 8, wherein the left image and the right image are separated horizontally and have optical axes which are aligned in parallel.

15. An imaging device, comprising:
goggles having a first display system and a second display system, the first display system providing information to a left eye of a user and the second display system providing information to a right eye of the user, wherein the first display system and the second display system each comprise one or more displays;
one or more cameras, the cameras receiving image data;
one or more sensors, the sensors configured to collect data regarding acceleration, gravity field direction and magnetic direction as related to the goggles;
a microphone affixed to the goggles, the microphone configured to receive input from a user, wherein the input from the user comprises one or more activity commands; and
a display controller configured to:
receive the image data from the cameras;
receive data from the one or more sensors;
process user input as received by the microphone; and
produce an adjusted image, the adjusted image compensating for a retinal disease of the user, the first display system and the second display system receiving the adjusted image, the display controller being connected with a computer, the display controller providing information about changes in the retinal disease of the user.
